(19) United States
(12) Patent Application Publication
(10) Pub. No.: US 2022/0004337 A1
(43) Pub. Date: Jan. 6, 2022

(54) COMMAND PRIORITIZATION IN A COMMAND QUEUE

(71) Applicant: Micron Technology, Inc., Boise, ID (US)

(72) Inventors: Giuseppe Cariello, Boise, ID (US); Jonathan Scott Parry, Boise, ID (US); Qing Liang, Boise, ID (US)

(21) Appl. No.: 16/921,410

(22) Filed: Jul. 6, 2020

(51) Int. Cl. G06F 3/06; G06F 9/48; G06F 9/38

(52) U.S. Cl. CPC G06F 3/0659; G06F 3/0653; G06F 9/3855; G06F 3/0679; G06F 9/4881; G06F 3/0611

(57) ABSTRACT

Devices and techniques for command prioritization in a command queue of a memory device are described herein. A command can be received at the memory device. An expiration time for the command can be obtained and the command can be placed into the command queue. Entries in the command queue are ordered by expiration times of commands stored therein, such that earlier entries are closer to the head of the command queue. When the memory controller is able to perform a command, the memory controller selects the next command at the head of the command queue to perform.

### BACKGROUND

Memory devices are typically provided as internal, semiconductor, integrated circuits in computers or other electronic devices. There are many different types of memory, including volatile and non-volatile memory.

Volatile memory requires power to maintain its data, and includes random-access memory (RAM), dynamic random-access memory (DRAM), or synchronous dynamic random-access memory (SDRAM), among others.

Non-volatile memory can retain stored data when not powered, and includes flash memory, read-only memory (ROM), electrically erasable programmable ROM (EEPROM), static RAM (SRAM), erasable programmable ROM (EPROM), resistance variable memory, such as phase-change random-access memory (PCRAM), resistive random-access memory (RRAM), magnetoresistive random-access memory (MRAM), or 3D XPoint™ memory, among others.

Memory devices are often accessed by a hardware and messaging protocol. For example, the memory device can operate in accordance with a variety of standards, such as a Universal Flash Storage (UFS™) device, or an embedded MMC device (eMMC™), etc. For example, in the case of the above examples, UFS devices can be configured in accordance with Joint Electron Device Engineering Council (JEDEC) standards (e.g., JEDEC standard JESD223D, entitled JEDEC UFS Flash Storage 3.0, etc., and/or updates or subsequent versions to such standard. Similarly, identified eMMC devices can be configured in accordance with JEDEC standard JESD84-A51, entitled “JEDEC eMMC standard 5.1”, again, and/or updates or subsequent versions to such standard. The memory device can also communicate via a variety of interfaces, such as a Serial Advanced Technology Attachment (SATA) interface, a Peripheral Component Interconnect Express (PCIe) interface, a Universal Serial Bus (USB) interface, a UFS interface, an eMMC™ interface, or one or more other connectors or interfaces.

### BRIEF DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various embodiments discussed in the present document.

FIG. 1 illustrates an example of an environment including a memory device.

FIG. 2 illustrates an example hardware relationship between components.

FIG. 3 illustrates an example of a workflow to insert a command into an expiration time ordered command queue.

FIG. 4 illustrates a flowchart of an example of a method for command prioritization in a command queue of a memory device.

FIG. 5 is a block diagram illustrating an example of a machine upon which one or more embodiments can be implemented.

### DETAILED DESCRIPTION

Memory device systems that support command queues, such as UFS and eMMc, generally enable command prioritization, whereby a command can be designated to execute out-of-order when it has a higher priority, for example. Command prioritization can provide several benefits, such as meeting quality-of-service (QoS) rules, or to ensure that later critical commands are executed as soon as possible. Thus, command prioritization provides command execution flexibility that often leads to an improved user experience when using the memory device.

An issue can arise, however, when priority designations are not harmonized by users of the memory device. For example, a host entity continually specifying high priorities for commands, or an overly aggressive or rigid QoS implementation, can lead to command starvation for lower priority commands. Here, command starvation refers to a command in the command queue that does not progress towards execution fast enough to execution because higher priority commands continue to be moved in front of the lower priority command. Thus, the latency of the lower priority command is so high it can cause system failures (e.g., a command timeout).

A technique to address command starvation involves recording a timestamp for incoming commands. The timestamp is used to periodically check whether a command is starving. If starvation is detected, the command's priority can be increased, increasing the likelihood that the command will not be deferred by a new incoming command. Although the timestamp can provide information to help prevent command starvation, it comes at the cost of controller overhead. That is, the controller, such as through a watchdog process or hardware, maintains a watch on each command slot in the command queue and calculates a starvation metric to determine whether the command priority should be increased. This overhead is compounded by a general inability of traditional hardware schedulers to managed execution of the commands in the queue because of the watchdog management of the command queue. Thus, simple hardware schedulers can have trouble, or be unable, to manage Small Computer System Interface (SCSI) command queue modifiers or priority recommendations—such as Head of Queue, Ordered, or Simple with or without a Command Priority flag—being restricted to Read over Write reordering.

In accordance with the techniques described herein, command starvation can be efficiently handled by a memory controller, or other device managing a command queue, using command expiration times rather than timestamps. Here, the expiration times are based on the arrival time, as well as priority or QoS input. The command queue can then be ordered by expiration time because the expiration time incorporates both when a command arrived as well as the command's priority. Thus, as time progresses, the priority of lower-priority commands is essentially automatically increasing with respect to later arriving commands. The head of the command queue generally holds the next command (or representation of the next command) to execute, alleviating complex processing by the memory controller.

As noted above, when a command is received, the expiration time is obtained (e.g., received, calculated, created, etc.). Once the expiration time is known, the command is inserted, in order of its expiration time, in the command queue. This is a straightforward technique whereby the new command's expiration time is compared with the command at the command queue tail. If the new command's expiration time is less than (e.g., earlier) than the command in the tail position, then the new command replaces the command at the tail. This comparison with the next command in the command queue is performed until the new command's expiration time is not smaller than the next command's expiration time. Thus, the command queue remains ordered, such that the head of the command queue is the next command to expire.

The expiration time incorporates prioritization or QoS signals for the command. For example, for SCSI Head of Queue commands, the expiration time can be the time when the command was received by the memory device (e.g., now) or in the past (e.g., a negative time from a current time or now). This will cause the Head of Queue command to sort near the head of the command queue. Ordered commands or Simple commands with low priority, for example, can be assigned an expiration time that is a fixed value to the time the command is received. In an example, this fixed time is based on a system expiration time for command performance. Thus, the command sorts later in the command queue if the command queue is full but is likely to finish before the system timeout. More generally, the fixed value can be directly correlated to the command priority. Thus, higher priority commands are given a smaller offset to the current time, resulting in an earlier execution, than a lower priority command received by the memory device at the same time.

Using expiration times and an ordered command queue provides a robust technique to avoid low-priority command starvation. This effect is achieved without sophisticated command scheduling, or cumbersome queue management. To allow starving commands to be executed before incoming HoQ commands (if allowed by host, during device configuration or dynamically) the expiration time for normal commands are determined by subtracting a margin from the system timeout so that an incoming HoQ command with expiration time set to zero will be enqueued after a command with a negative (e.g., overdue) expiration time. Additional details and examples are provided below.

The following notes provide context to the discussion herein. Memory devices include individual memory die, which can, for example, include including a storage region comprising one or more arrays of memory cells, implementing one (or more) selected storage technologies. Such memory die will often include support circuitry for operating the memory array(s). Other examples, sometimes known generally as “managed memory devices,” include assemblies of one or more memory die associated with controller functionality configured to control operation of the one or more memory die. Such controller functionality can simplify interoperability with an external device, as a “host” as discussed later herein. In such managed memory devices the controller functionality can be implemented on one or more die also incorporating a memory array, or on a separate die). In other examples, one or more memory devices can be combined with controller functionality to form a solid-stage drive (SSD) storage volume. The term “memory system,” is used herein as inclusive of one or more memory die, and any controller functionality for such memory die, when present; and thus includes individual memory devices, managed memory devices, and SSDs.

Embodiments of the present disclosure are described in the example of managed memory devices implementing NAND flash memory cells, termed “managed NAND” devices. These examples, however, are not limiting on the scope of the disclosure, which can be implemented in other forms of memory devices and/or with other forms of storage technology.

Each flash memory cell in a NOR or NAND architecture semiconductor memory array can be programmed individually or collectively to one or a number of programmed states. For example, a single-level cell (SLC) can represent one of two programmed states (e.g., 1 or 0), representing one bit of data. Flash memory cells can also represent more than two programmed states, allowing the manufacture of higher density memories without increasing the number of memory cells, as each cell can represent more than one binary digit (e.g., more than one bit). Such cells can be referred to as multi-state memory cells, multi-digit cells, or multi-level cells (MLCs). In certain examples, MLC can refer to a memory cell that can store two bits of data per cell (e.g., one of four programmed states), a triple-level cell (TLC) can refer to a memory cell that can store three bits of data per cell (e.g., one of eight programmed states), and a quad-level cell (QLC) can store four bits of data per cell. MLC is used herein in its broader context, to refer to any memory cell(s) that can store more than one bit of data per cell (i.e., that can represent more than two programmed states).

Managed memory devices can be configured and operated in accordance with recognized industry standards. For example, managed NAND devices can be (as non-limiting examples), a Universal Flash Storage (UFS™) device, or an embedded MMC device (eMMC™), etc. For example, in the case of the above examples, UFS devices can be configured in accordance with Joint Electron Device Engineering Council (JEDEC) standards (e.g., JEDEC standard JESD223E, entitled JEDEC UFS Flash Storage 3.1, etc., and/or updates or subsequent versions to such standard. Similarly, identified eMMC devices can be configured in accordance with JEDEC standard JESD84-A51, entitled “JEDEC eMMC standard 5.1”, again, and/or updates or subsequent versions to such standard. The identified standards are provided only as example environments in which the described methods and structures may be utilized. Such methods and structures may be utilized in a variety of environments outside of the identified standards (or of any other actual or proposed standards), except as expressly indicated herein.

An SSD can be used as, among other things, the main storage device of a computer, having advantages over traditional hard drives with moving parts with respect to, for example, performance, size, weight, ruggedness, operating temperature range, and power consumption. For example, SSDs can have reduced seek time, latency, or other delay associated with magnetic disk drives (e.g., electromechanical, etc.). SSDs use non-volatile memory cells, such as flash memory cells to obviate internal battery supply requirements, thus allowing the drive to be more versatile and compact. Managed memory devices, for example managed NAND devices, can be used as primary or ancillary memory in various forms of electronic devices, and are commonly used in mobile devices.

Both SSDs and managed memory devices can include a number of memory devices, including a number of dies or logical units (e.g., logical unit numbers or LUNs), and can include one or more processors or other controllers performing logic functions required to operate the memory devices or interface with external systems. Such SSDs and managed memory devices can include one or more flash memory die, including several memory arrays and peripheral circuitry thereon. The flash memory arrays can include several blocks of memory cells organized into several physical pages. In some examples, the SSDs can also include DRAM or SRAM (or other forms of memory die or other memory structures). Similarly, managed NAND devices can include one or more arrays of volatile and/or nonvolatile memory separate from the NAND storage array, and either within or separate from a controller. Both SSDs and managed NAND devices can receive commands from a host in association with memory operations, such as read or write operations to transfer data (e.g., user data and associated integrity data, such as error data and address data, etc.) between the memory devices and the host, or erase operations to erase data from the memory devices.

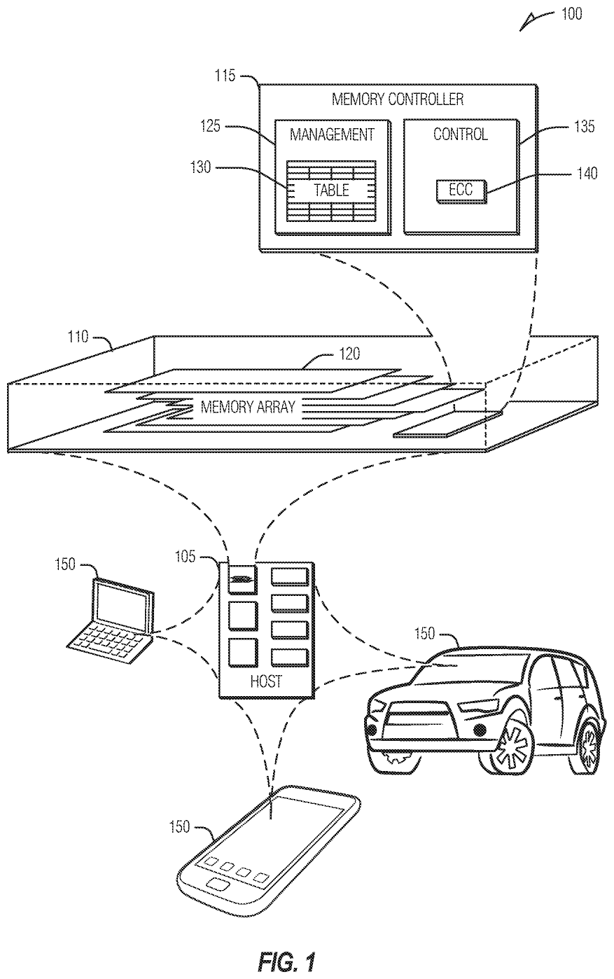

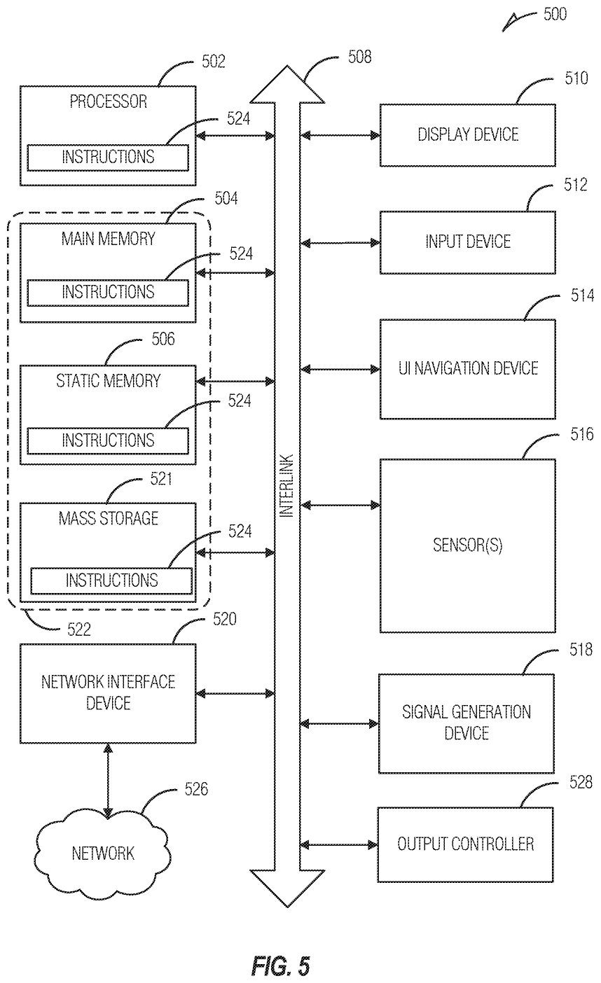

FIG. 1 illustrates an example of an environment 100 including a host device 105 and a memory device 110 configured to communicate over a communication interface. The host device 105 or the memory device 110 can be included in a variety of products 150, such as Internet of Things (IoT) devices (e.g., a refrigerator or other appliance, sensor, motor or actuator, mobile communication device, automobile, drone, etc.) to support processing, communications, or control of the product 150. The host device 105 can include a host system, an electronic device, a processor, a memory card reader, or one or more other electronic devices external to the memory device 110. In some examples, the host 105 can be a machine having some portion, or all, of the components discussed in reference to the machine 500 of FIG. 5.

The memory device 110 includes a memory controller 115 and a memory array 120 including, for example, several individual memory die (e.g., a stack of three-dimensional (3D) NAND die). In 3D architecture semiconductor memory technology, vertical structures are stacked, increasing the number of tiers, physical pages, and accordingly, the density of a memory device (e.g., a storage device). In an example, the memory device 110 can be a discrete memory or storage device component of the host device 105. In other examples, the memory device 110 can be a portion of an integrated circuit (e.g., system on a chip (SOC), etc.), stacked or otherwise included with one or more other components of the host device 105.

The memory controller 115 can receive instructions from the host 105, and can communicate with the memory array 120, such as to transfer data to (e.g., write or erase) or from (e.g., read) one or more of the memory cells, planes, sub-blocks, blocks, or pages of the memory array 120. For example, the memory controller 115 can include one or more memory control units, circuits, or components configured to control access across the memory array 120 and to provide a translation layer between the host 105 and the memory device 110.

The memory controller 115 includes processing circuitry, which may include one or more processors which, when present, operate to execute instructions stored in the memory device, and may include additional circuitry or components. For purposes of the present examples, the instructions will be discussed as firmware, though instructions may also be present as software; and all or some portion of the described functions may also be implemented in circuitry including one or more components or integrated circuits. In some examples, the functions of memory controller 115 are implemented by a processor executing the instructions of firmware which in some examples would be stored within the memory controller 115. In other examples, one or more processors within memory controller 115, may execute instructions stored in the memory array 120, which may be loaded into working memory in memory controller 115. Similarly, the management tables 130 used by the controller can be stored on the memory controller 115 or in memory array 120. In such examples the instructions and/or management tables 130 may be stored in certain blocks of the NAND die of memory array 120 and loaded into the working memory of memory controller 115 during operation. The memory controller 115 can include, among other things, circuitry or firmware, including one or more components or integrated circuits.

One or more communication interfaces can be used to transfer data between the memory device 110 and one or more other components of the host device 105, such as a Serial Advanced Technology Attachment (SATA) interface, a Peripheral Component Interconnect Express (PCIe) interface, a Universal Serial Bus (USB) interface, a UFS interface, an eMMC™ interface, or one or more other connectors or interfaces. As part of supporting these interfaces, the memory controller 115 includes a command queue. The command queue is ordered by expiration times. For example, given a current time T, a command with expiration time T+1 milliseconds is ordered closer to the head of the command queue than a command with an expiration time of T+100 milliseconds. The memory controller 115 can have multiple command queues depending upon its configuration, and the time-based priority sorting described herein can be used for any of these queues in which priority is addressed. Thus, for example, if a NAND flash controller had separate command queues for each die in a memory array 120, then each of these command queues can operate as the single command queue described in the examples below.

The memory controller 115 is configured to receive a command and obtain an expiration time for the command. In an example, the memory controller 115 obtains the expiration time for the command by reading the expiration time from a message used to deliver the command to the memory device 110. In this example, the host 105 creates the expiration time, relieving the memory controller 115 from having to perform the task.

In an example, to obtain the expiration time, the memory controller 115 is configured to create the expiration time. Creating the expiration time involves adding one or more time-values (e.g., milliseconds) to a current time (e.g., the time the command was received by the memory device 110). These additional values can be chosen or themselves calculated in a variety of ways. For example, assume a priority scheme with four priority levels. A fixed value can be multiplied by the level and added to the current time. Thus, a level 4 priority command will have four times as much time added to the current time ad a level 1 priority command. A non-linear function can also be used to select values to priority levels. Thus, in an example, the memory controller 115 is configured to obtain a characteristic of the command and create the expiration time by combining a current time the command was received to a time-value that corresponds to the characteristic. In an example, the characteristic is a priority of the command.

Whatever technique is used to arrive at the expiration time, the expiration time operates within the context of the expiration-time-ordered command queue and a current time for the memory controller 115. Thus, in an example, the expiration time is created such that it is lower for a higher priority command. Thus, betwixt two commands received at the same time, one having a higher priority than the other, the higher priority command has a lower (e.g., earlier) expiration time than the other command. In an example, a highest priority command has a zero or negative expiration time. Here, a zero-expiration time is equal to a current time and a negative expiration time is prior to a current time. Thus, logically, a negative expiration time is “overdue.” However, these times are used as an ordering element and do not otherwise impact the command execution. Thus, even if the expiration time has elapsed, the command can be removed from the head of the command queue and executed.

In an example, a lowest priority has a maximum expiration time. The maximum expiration time can be a setting. In an example, the maximum expiration time is based off a command timeout value for the memory device 110 or the host 105. In an example, the maximum expiration time is a percentage of the timeout value.

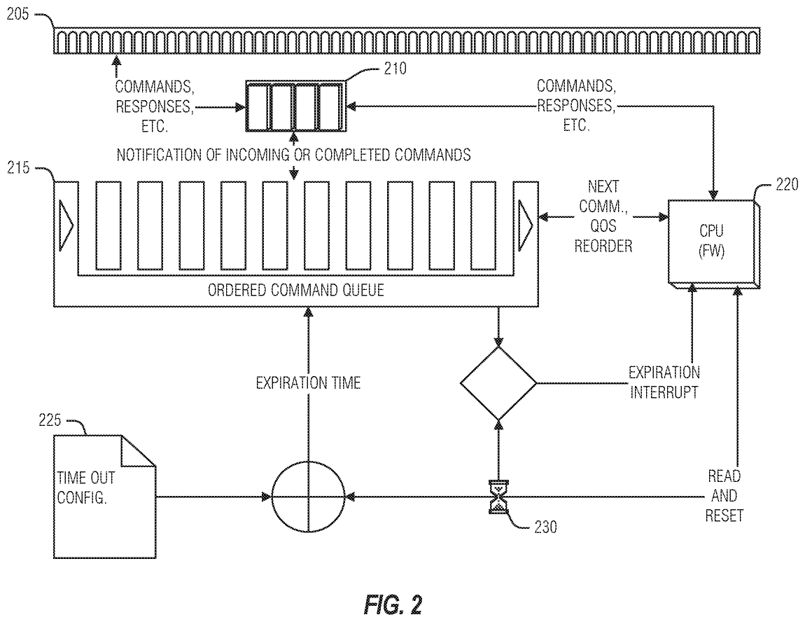

As noted above, once the expiration time is obtained, the memory controller 115 is configured to sort, based on the expiration time, the command among other pending commands of the memory controller 115. The sorting is accomplished by using the command queue. Specifically, representations of the command and the other pending commands are placed in the command queue. These representations can be the command itself (e.g., some or all of the message that delivered the command to the memory controller 115) or can be an identifier (e.g., a key, index, etc.) to another memory location holding the command. An example of this second form of the command representation is illustrated in FIG. 2 and described below.

In an example, the command queue is ordered solely by expiration times of commands represented therein. When only expiration times are used to order the command queue, complexity in the memory controller 115 is simplified over traditional technique. In an example, the expiration times of commands stored in the command queue are immutable. Being immutable simplifies memory controller 115 design. Thus, using a sort-on-insert technique ensures that the command queue remains sorted without additional operations or ongoing watchdog processes. In an example, the memory controller 115 is configured to sort the command queue by placing the representation of the command at a tail of the command queue and repeatedly swapping with the representation of a next command in the command queue when the next command has a larger (e.g., later or further into the future from a current time) expiration time than the expiration time for the command.

The memory controller 115 is configured to initiate performance of (e.g., to execute) the command in response to the representation of the command being at the head of the command queue. Thus, when execution resources are freed to execute a command by the memory controller 115, the memory controller 115 need only pop the head element from the command queue. Because the expiration time encompasses priority information, and the clock represents a current time, an elegant solution to command starvation is achieved while still enabling commands to have different priorities. In effect, the march of time operates to incrementally increase the priority of aging commands to address the starvation issue without additional processing by the memory controller 115.

The memory manager 125 can include, among other things, circuitry or firmware, such as several components or integrated circuits associated with various memory management functions. For purposes of the present description example memory operation and management functions will be described in the context of NAND memory. Persons skilled in the art will recognize that other forms of non-volatile memory can have analogous memory operations or management functions. Such NAND management functions include wear leveling (e.g., garbage collection or reclamation), error detection or correction, block retirement, or one or more other memory management functions. The memory manager 125 can parse or format host commands (e.g., commands received from a host) into device commands (e.g., commands associated with operation of a memory array, etc.), or generate device commands (e.g., to accomplish various memory management functions) for the array controller 135 or one or more other components of the memory device 110.

The memory manager 125 can include a set of management tables 130 configured to maintain various information associated with one or more component of the memory device 110 (e.g., various information associated with a memory array or one or more memory cells coupled to the memory controller 115). For example, the management tables 130 can include information regarding block age, block erase count, error history, or one or more error counts (e.g., a write operation error count, a read bit error count, a read operation error count, an erase error count, etc.) for one or more blocks of memory cells coupled to the memory controller 115. In certain examples, if the number of detected errors for one or more of the error counts is above a threshold, the bit error can be referred to as an uncorrectable bit error. The management tables 130 can maintain a count of correctable or uncorrectable bit errors, among other things. In an example, the management tables 130 can include translation tables or a L2P mapping.

The array controller 135 can include, among other things, circuitry or components configured to control memory operations associated with writing data to, reading data from, or erasing one or more memory cells of the memory device 110 coupled to the memory controller 115. The memory operations can be based on, for example, host commands received from the host 105, or internally generated by the memory manager 125 (e.g., in association with wear leveling, error detection or correction, etc.).

The array controller 135 can include an error correction code (ECC) component 140, which can include, among other things, an ECC engine or other circuitry configured to detect or correct errors associated with writing data to or reading data from one or more memory cells of the memory device 110 coupled to the memory controller 115. The memory controller 115 can be configured to actively detect and recover from error occurrences (e.g., bit errors, operation errors, etc.) associated with various operations or storage of data, while maintaining integrity of the data transferred between the host 105 and the memory device 110, or maintaining integrity of stored data (e.g., using redundant RAID storage, etc.), and can remove (e.g., retire) failing memory resources (e.g., memory cells, memory arrays, pages, blocks, etc.) to prevent future errors.

The memory array 120 can include several memory cells arranged in, for example, several devices, planes, sub-blocks, blocks, or pages. As one example, a 48 GB TLC NAND memory device can include 18,592 bytes (B) of data per page (16,384+2208 bytes), 1536 pages per block, 548 blocks per plane, and 4 or more planes per device. As another example, a 32 GB MLC memory device (storing two bits of data per cell (i.e., 4 programmable states)) can include 18,592 bytes (B) of data per page (16,384+2208 bytes), 1024 pages per block, 548 blocks per plane, and 4 planes per device, but with half the required write time and twice the program/erase (P/E) cycles as a corresponding TLC memory device. Other examples can include other numbers or arrangements. In some examples, a memory device, or a portion thereof, can be selectively operated in SLC mode, or in a desired MLC mode (such as TLC, QLC, etc.).

In operation, for example when the memory array is a NAND array, data is typically written to or read from the memory device 110 in pages and erased in blocks. However, one or more memory operations (e.g., read, write, erase, etc.) can be performed on larger or smaller groups of memory cells, as desired. The data transfer size of a memory device 110 is typically referred to as a page, whereas the data transfer size of a host is typically referred to as a sector.

Although a page of data can include a number of bytes of user data (e.g., a data payload including a number of sectors of data) and its corresponding metadata, the size of the page often refers only to the number of bytes used to store the user data. As an example, a page of data having a page size of 4 KB can include 4 KB of user data (e.g., 8 sectors assuming a sector size of 512 B) as well as a number of bytes (e.g., 32 B, 54 B, 224 B, etc.) of metadata corresponding to the user data, such as integrity data (e.g., error detecting or correcting code data), address data (e.g., logical address data, etc.), or other metadata associated with the user data.

Different types of memory cells or memory arrays 120 can provide for different page sizes or can require different amounts of metadata associated therewith. For example, different memory device types can have different bit error rates, which can lead to different amounts of metadata necessary to ensure integrity of the page of data (e.g., a memory device with a higher bit error rate can require more bytes of error correction code data than a memory device with a lower bit error rate). As an example, a multi-level cell (MLC) NAND flash device can have a higher bit error rate than a corresponding single-level cell (SLC) NAND flash device. As such, the MLC device can require more metadata bytes for error data than the corresponding SLC device.

FIG. 2 illustrates an example hardware relationship between components, for example, in the memory controller 115 of FIG. 1. As illustrated, the host interface 205 is used to communicate messages to the host and the memory controller 115. A buffer 210 stores command slots in which the commands and responses reside. In an example, the command slots hold the data of a command, which includes meta data or protocol data (e.g., In/Out UFS protocol information unit (UPIU)). The buffer 210 is implemented in working memory (e.g., static random-access memory (SRAM)) of the memory controller, in registers, or other hardware to host the command slots. The buffer 210 is connected to processing circuitry 220 (e.g., processing circuitry of the memory controller 115), which can use firmware (e.g., instructions) to execute the commands.

The command queue 215, as illustrated here, is a separate element from the command slots in the buffer 210. Here, an element in the command queue 215 (e.g., a representation of a command) includes an expiration time and an index into the command slots. Accordingly, when ordering the command queue 215, the entire command is not moved between elements of the command queue 215, but only the expiration time and the index. This arrangement can provide for a more compact command queue in terms of space and processing. In an example, there can be a one-to-one correspondence between command slots in the buffer 210 and elements in the command queue. In an example, the elements can also include priority-relevant command attributes, such as a priority assigned to the command by an issuing process, an identifier of an issuing process for the command, a priority assigned to data affected by the command, etc.

The timer 230 provides a base time that is combined with the time out configuration 225 to create an expiration time. As illustrated, the timer 230 can also be used in a decision to interrupt the processing circuitry 220 when a command has expired or will expire within a threshold time. The time out configuration 225 includes values or rules to create the expiration time for a command. Thus, incoming commands are given an initial expiration time that can be reduced to satisfy QoS or priority rules embodied by the time out configuration. For example, to avoid starvation of low priority commands, a rule “expired commands before incoming high priority commands” can be applied. In an example, priority rules can dynamically change based on detected workload or a setting made by a user, the host, etc.

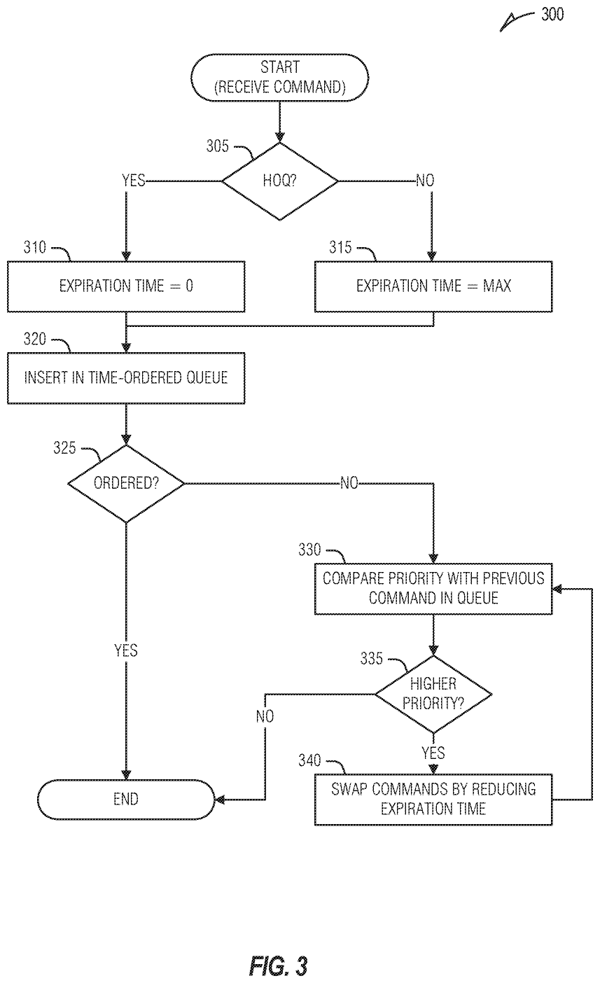

FIG. 3 illustrates an example of a workflow 300 to insert a representation of a command into an expiration time ordered command queue, such as command queue 215 of FIG. 2. This workflow 300 determines whether the command is designated as a head-of-queue (HoQ) command by the submitter (decision 305). If yes, then the command is given a minimum expiration time (here designated as 0) (operation 310). If the command is not HoQ (decision 305), the command is given a maximum expiration time (operation 315).

Once the expiration time is determined, the representation of the command is inserted into the expiration time ordered queue (operation 320). By virtue of queue operation, this insertion is at the end, or tail, or the queue. The command queue is checked to determine whether it is ordered (decision 325). This can involve comparing the expiration of the new command with the next command (operation 330) to determine whether the new expiration time command is lower (e.g., will expire sooner) (decision 335). If this is not true, then the queue is ordered and the workflow 300 ends.

When the new command expiration time is less than the representation of the next command in the command queue (decision 335), the representations of the commands switch places in the command queue (operation 340). The process repeats until the new command expiration time is no longer sooner than the next command (decision 335).

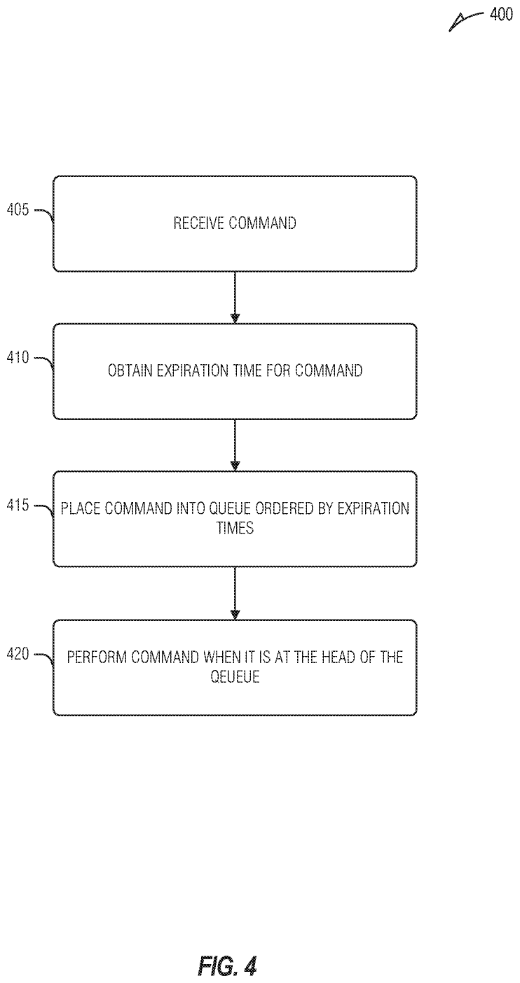

FIG. 4 illustrates a flowchart of an example of a method 400 for command prioritization in a command queue (e.g., command queue 215) in a memory device. The method 400 can be used, for example, in performance of the workflow 300, of FIG. 3. Accordingly, it should be recognized that, in some examples, respective portions of workflow 300 can be included in the operations of method 400. The operations of the method 400 are performed, for example, by computing hardware, software (firmware), or a combination thereof. An example of such computing hardware can include the memory controller 115 or other processing circuitry of the memory device 110 described above with respect to FIG. 1, or by other computer components, such as an external memory controller. In some examples, method 400 can be implemented as firmware including instructions, which when executed by the memory controller 115, cause the memory controller 115 to perform the operations of method 400.

At operation 405 a command is received at the memory device.

At operation 410, an expiration time for the command is obtained. In an example, obtaining the expiration time for the command includes reading from a message used to deliver the command to the memory device.

In an example, obtaining the expiration time for the command includes creating the expiration time by the memory device. In an example, the expiration time is lower for a higher priority. In an example, a lowest priority has a maximum expiration time (e.g., as defined by the memory device). In an example, a highest priority has a zero or negative expiration time.

In an example, creating the expiration time by the memory device includes obtaining a characteristic of the command and adding a time-value corresponding to the characteristic to a current time that the command was received. In an example, the characteristic is a priority of the command.

At operation 415, a representation of the command is placed into the command queue. Placing the representation of the command includes, for example, ordering the command queue. In particular, the representation of the command is sorted among representations of other pending commands in the command queue. Here, the command queue is ordered solely by expiration times of commands represented therein (e.g., expiration times of the command and the other pending commands represented in the command queue). In an example, the expiration times of commands represented in the command queue are immutable. In an example, sorting the command into the command queue includes placing the representation of the command at a tail of the command queue and repeatedly swapping the representation of the command with a representation of a next command in the command queue when the next command has a larger expiration time that the expiration time for the command.

At operation 420, the command is performed in response to the command being at the head of the command queue.

FIG. 5 illustrates a block diagram of an example machine 500 upon which any one or more of the techniques (e.g., methodologies) discussed herein can perform. For example, any of the memory systems within machine 500 (main memory 504, static memory 506, and mass storage 521) may implement command prioritization in a command queue as discussed relative to FIGS. 1-4 herein. In alternative embodiments, the machine 500 can operate as a standalone device or can be connected (e.g., networked) to other machines. In a networked deployment, the machine 500 can operate in the capacity of a server machine, a client machine, or both in server-client network environments. In an example, the machine 500 can act as a peer machine in peer-to-peer (P2P) (or other distributed) network environment. The machine 500 can be a personal computer (PC), a tablet PC, a set-top box (STB), a personal digital assistant (PDA), a mobile telephone, a web appliance, an IoT device, automotive system, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, can include, or can operate by, logic, components, devices, packages, or mechanisms. Circuitry is a collection (e.g., set) of circuits implemented in tangible entities that include hardware (e.g., simple circuits, gates, logic, etc.). Circuitry membership can be flexible over time and underlying hardware variability. Circuitries include members that can, alone or in combination, perform specific tasks when operating. In an example, hardware of the circuitry can be immutably designed to carry out a specific operation (e.g., hardwired). In an example, the hardware of the circuitry can include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable participating hardware (e.g., the execution units or a loading mechanism) to create members of the circuitry in hardware via the variable connections to carry out portions of the specific tasks when in operation. Accordingly, the computer readable medium is communicatively coupled to the other components of the circuitry when the device is operating. In an example, any of the physical components can be used in more than one member of more than one circuitry. For example, under operation, execution units can be used in a first circuit of a first circuitry at one point in time and reused by a second circuit in the first circuitry, or by a third circuit in a second circuitry at a different time.

The machine (e.g., computer system) 500 (e.g., the host device 105, the memory device 110, etc.) can include a hardware processor 502 (e.g., a central processing unit (CPU), a graphics processing unit (GPU), a hardware processor core, or any combination thereof, such as the memory controller 115, etc.), a main memory 504 and a static memory 506, some or all of which can communicate with each other via an interlink (e.g., bus) 508. The machine 500 can further include a display unit 510, an alphanumeric input device 512 (e.g., a keyboard), and a user interface (UI) navigation device 514 (e.g., a mouse). In an example, the display unit 510, input device 512 and UI navigation device 514 can be a touch screen display. The machine 500 can additionally include a storage device (e.g., drive unit) 521, a signal generation device 518 (e.g., a speaker), a network interface device 520, and one or more sensors 516, such as a global positioning system (GPS) sensor, compass, accelerometer, or other sensor. The machine 500 can include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 can include a machine readable medium 522 on which is stored one or more sets of data structures or instructions 524 (e.g., software) embodying or utilized by any one or more of the techniques or functions described herein. The instructions 524 can also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 can constitute the machine readable medium 522.

While the machine readable medium 522 is illustrated as a single medium, the term “machine readable medium” can include a single medium or multiple media (e.g., a centralized or distributed database, or associated caches and servers) configured to store the one or more instructions 524.

The term “machine readable medium” can include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine-readable medium examples can include solid-state memories, and optical and magnetic media. In an example, a massed machine-readable medium comprises a machine-readable medium with a plurality of particles having invariant (e.g., rest) mass. Accordingly, massed machine-readable media are not transitory propagating signals. Specific examples of massed machine readable media can include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 (e.g., software, programs, an operating system (OS), etc.) or other data are stored on the storage device 521, can be accessed by the memory 504 for use by the processor 502. The memory 504 (e.g., DRAM) is typically fast, but volatile, and thus a different type of storage than the storage device 521 (e.g., an SSD), which is suitable for long-term storage, including while in an “off” condition. The instructions 524 or data in use by a user or the machine 500 are typically loaded in the memory 504 for use by the processor 502. When the memory 504 is full, virtual space from the storage device 521 can be allocated to supplement the memory 504; however, because the storage 521 device is typically slower than the memory 504, and write speeds are typically at least twice as slow as read speeds, use of virtual memory can greatly reduce user experience due to storage device latency (in contrast to the memory 504, e.g., DRAM). Further, use of the storage device 521 for virtual memory can greatly reduce the usable lifespan of the storage device 521.

In contrast to virtual memory, virtual memory compression (e.g., the Linux® kernel feature “ZRAM”) uses part of the memory as compressed block storage to avoid paging to the storage device 521. Paging takes place in the compressed block until it is necessary to write such data to the storage device 521. Virtual memory compression increases the usable size of memory 504, while reducing wear on the storage device 521.

Storage devices optimized for mobile electronic devices, or mobile storage, traditionally include MMC solid-state storage devices (e.g., micro Secure Digital (microSD™) cards, etc.). MMC devices include several parallel interfaces (e.g., an 8-bit parallel interface) with a host device and are often removable and separate components from the host device. In contrast, eMMC™ devices are attached to a circuit board and considered a component of the host device, with read speeds that rival serial ATA™ (Serial AT (Advanced Technology) Attachment, or SATA) based SSD devices. However, demand for mobile device performance continues to increase, such as to fully enable virtual or augmented-reality devices, utilize increasing networks speeds, etc. In response to this demand, storage devices have shifted from parallel to serial communication interfaces. Universal Flash Storage (UFS) devices, including controllers and firmware, communicate with a host device using a low-voltage differential signaling (LVDS) serial interface with dedicated read/write paths, further advancing greater read/write speeds.

The instructions 524 can further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 520 can include one or more physical jacks (e.g., Ethernet, coaxial, or phone jacks) or one or more antennas to connect to the communications network 526. In an example, the network interface device 520 can include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software.

### Additional Examples

Example 1 is a memory device, comprising: a memory array; and a memory controller including, a command queue buffer; and processing circuitry including one or more hardware processors, the processing circuitry configured to perform operations to implement command prioritization in a command queue of the memory device, the operations comprising: receive a command at the memory device; obtain an expiration time for the command; sort, based on the expiration time for the command, the command among other pending commands by use of a command queue solely ordered by expiration times of commands represented therein, wherein the expiration times of commands represented in the command queue are immutable; and in response to a representation of the command being at the head of the command queue, initiate performance of the command against the memory array.

In Example 2, the subject matter of Example 1 includes, wherein, to obtain the expiration time for the command, the processing circuitry is configured to read from a message used to deliver the command to the memory device.

In Example 3, the subject matter of Examples 1-2 includes, wherein, to obtain the expiration time for the command, the processing circuitry is configured to create the expiration time by the memory device.

In Example 4, the subject matter of Example 3 includes, wherein, to create the expiration time by the memory device, the processing circuitry is configured to: obtain a characteristic of the command; and add a time that the command was received to a time-value corresponding to the characteristic of the command.

In Example 5, the subject matter of Example 4 includes, wherein the characteristic is a priority of the command.

In Example 6, the subject matter of Example 5 includes, wherein the expiration time is lower for a higher priority.

In Example 7, the subject matter of Example 6 includes, wherein a lowest priority has a maximum expiration time.

In Example 8, the subject matter of Examples 6-7 includes, wherein a highest priority has a zero or negative expiration time.

In Example 9, the subject matter of Examples 1-8 includes, wherein, to sort the command among other pending commands by use of the command queue solely ordered by expiration times of commands represented therein into the command queue, the processing circuitry is configured to: place the representation of the command at a tail of the command queue; and repeatedly swap the representation of the command with a representation of a next command in the command queue when the next command has a larger expiration time that the expiration time for the command.

Example 10 is a method for command prioritization in a command queue of a memory device, the method comprising: receiving a command at the memory device; obtaining an expiration time for the command; sorting, based on the expiration time for the command, the command among other pending commands by use of a command queue solely ordered by expiration times of commands represented therein, wherein the expiration times of commands represented in the command queue are immutable; and in response to a representation of the command being at the head of the command queue, initiating performance of the command against the memory array.

In Example 11, the subject matter of Example 10 includes, wherein obtaining the expiration time for the command includes reading from a message deliver the command to the memory device.

In Example 12, the subject matter of Examples 10-11 includes, wherein obtaining the expiration time for the command includes creating the expiration time by the memory device.

In Example 13, the subject matter of Example 12 includes, wherein creating the expiration time by the memory device includes: obtaining a characteristic of the command; and adding a time that the command was received to a time-value corresponding to the characteristic of the command.

In Example 14, the subject matter of Example 13 includes, wherein the characteristic is a priority of the command.

In Example 15, the subject matter of Example 14 includes, wherein the expiration time is lower for a higher priority.

In Example 16, the subject matter of Example 15 includes, wherein a lowest priority has a maximum expiration time.

In Example 17, the subject matter of Examples 15-16 includes, wherein a highest priority has a zero or negative expiration time.

In Example 18, the subject matter of Examples 10-17 includes, wherein sorting the command among other pending commands by use of the command queue solely ordered by expiration times of commands represented therein into the command queue includes: placing the representation of the command at a tail of the command queue; and repeatedly swapping the representation of the command with a representation of a next command in the command queue when the next command has a larger expiration time that the expiration time for the command.

Example 19 is a machine-readable medium including instructions that, when executed by circuitry, configure the circuitry to perform any method of Examples 10-18.

Example 20 is a system comprising means to perform any method of Examples 10-18.

Example 21 is a non-transitory machine-readable medium including instructions for command prioritization in a command queue of a memory device, the instructions, when executed, cause processing circuitry of the memory device to perform operations comprising: receiving a command at the memory device; obtaining an expiration time for the command; sorting, based on the expiration time for the command, the command among other pending commands by use of a command queue solely ordered by expiration times of commands represented therein, wherein the expiration times of commands represented in the command queue are immutable; and in response to a representation of the command being at the head of the command queue, initiating performance of the command against the memory array.

In Example 22, the subject matter of Example 21 includes, wherein obtaining the expiration time for the command includes reading from a message deliver the command to the memory device.

In Example 23, the subject matter of Examples 21-22 includes, wherein obtaining the expiration time for the command includes creating the expiration time by the memory device.

In Example 24, the subject matter of Example 23 includes, wherein creating the expiration time by the memory device includes: obtaining a characteristic of the command; and adding a time that the command was received to a time-value corresponding to the characteristic of the command.

In Example 25, the subject matter of Example 24 includes, wherein the characteristic is a priority of the command.

In Example 26, the subject matter of Example 25 includes, wherein the expiration time is lower for a higher priority.

In Example 27, the subject matter of Example 26 includes, wherein a lowest priority has a maximum expiration time.

In Example 28, the subject matter of Examples 26-27 includes, wherein a highest priority has a zero or negative expiration time.

In Example 29, the subject matter of Examples 21-28 includes, wherein sorting the command among other pending commands by use of the command queue solely ordered by expiration times of commands represented therein into the command queue includes: placing the representation of the command at a tail of the command queue; and repeatedly swapping the representation of the command with a representation of a next command in the command queue when the next command has a larger expiration time that the expiration time for the command.

Example 30 is at least one machine-readable medium including instructions that, when executed by processing circuitry, cause the processing circuitry to perform operations to implement of any of Examples 1-29.

Example 31 is an apparatus comprising means to implement of any of Examples 1-29.

Example 32 is a system to implement of any of Examples 1-29.

Example 33 is a method to implement of any of Examples 1-29.

The above detailed description includes references to the accompanying drawings, which form a part of the detailed description. The drawings show, by way of illustration, specific embodiments in which the invention can be practiced. These embodiments are also referred to herein as “examples”. Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” can include “A but not B,” “B but not A,” and “A and B,” unless otherwise indicated. In the appended claims, the terms “including” and “in which” are used as the plain-English equivalents of the respective terms “comprising” and “wherein”. Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

In various examples, the components, controllers, processors, units, engines, or tables described herein can include, among other things, physical circuitry or firmware stored on a physical device. As used herein, “processor” means any type of computational circuit such as, but not limited to, a microprocessor, a microcontroller, a graphics processor, a digital signal processor (DSP), or any other type of processor or processing circuit, including a group of processors or multi-core devices.

The term “horizontal” as used in this document is defined as a plane parallel to the conventional plane or surface of a substrate, such as that underlying a wafer or die, regardless of the actual orientation of the substrate at any point in time. The term “vertical” refers to a direction perpendicular to the horizontal as defined above. Prepositions, such as “on,” “over,” and “under” are defined with respect to the conventional plane or surface being on the top or exposed surface of the substrate, regardless of the orientation of the substrate; and while “on” is intended to suggest a direct contact of one structure relative to another structure which it lies “on” (in the absence of an express indication to the contrary); the terms “over” and “under” are expressly intended to identify a relative placement of structures (or layers, features, etc.), which expressly includes—but is not limited to—direct contact between the identified structures unless specifically identified as such. Similarly, the terms “over” and “under” are not limited to horizontal orientations, as a structure can be “over” a referenced structure if it is, at some point in time, an outermost portion of the construction under discussion, even if such structure extends vertically relative to the referenced structure, rather than in a horizontal orientation.

The terms “wafer” and “substrate” are used herein to refer generally to any structure on which integrated circuits are formed, and also to such structures during various stages of integrated circuit fabrication. The following detailed description is, therefore, not to be taken in a limiting sense, and the scope of the various embodiments is defined only by the appended claims, along with the full scope of equivalents to which such claims are entitled.

Various embodiments according to the present disclosure and described herein include memory utilizing a vertical structure of memory cells (e.g., NAND strings of memory cells). As used herein, directional adjectives will be taken relative a surface of a substrate upon which the memory cells are formed (i.e., a vertical structure will be taken as extending away from the substrate surface, a bottom end of the vertical structure will be taken as the end nearest the substrate surface and a top end of the vertical structure will be taken as the end farthest from the substrate surface).

As used herein, directional adjectives, such as horizontal, vertical, normal, parallel, perpendicular, etc., can refer to relative orientations, and are not intended to require strict adherence to specific geometric properties, unless otherwise noted. For example, as used herein, a vertical structure need not be strictly perpendicular to a surface of a substrate, but can instead be generally perpendicular to the surface of the substrate, and can form an acute angle with the surface of the substrate (e.g., between 60 and 120 degrees, etc.).

In some embodiments described herein, different doping configurations can be applied to a source-side select gate (SGS), a control gate (CG), and a drain-side select gate (SGD), each of which, in this example, can be formed of or at least include polysilicon, with the result such that these tiers (e.g., polysilicon, etc.) can have different etch rates when exposed to an etching solution. For example, in a process of forming a monolithic pillar in a 3D semiconductor device, the SGS and the CG can form recesses, while the SGD can remain less recessed or even not recessed. These doping configurations can thus enable selective etching into the distinct tiers (e.g., SGS, CG, and SGD) in the 3D semiconductor device by using an etching solution (e.g., tetramethylammonium hydroxide (TMCH)).

Operating a memory cell, as used herein, includes reading from, writing to, or erasing the memory cell. The operation of placing a memory cell in an intended state is referred to herein as “programming,” and can include both writing to or erasing from the memory cell (e.g., the memory cell can be programmed to an erased state).

According to one or more embodiments of the present disclosure, a memory controller (e.g., a processor, controller, firmware, etc.) located internal or external to a memory device, is capable of determining (e.g., selecting, setting, adjusting, computing, changing, clearing, communicating, adapting, deriving, defining, utilizing, modifying, applying, etc.) a quantity of wear cycles, or a wear state (e.g., recording wear cycles, counting operations of the memory device as they occur, tracking the operations of the memory device it initiates, evaluating the memory device characteristics corresponding to a wear state, etc.)

According to one or more embodiments of the present disclosure, a memory access device can be configured to provide wear cycle information to the memory device with each memory operation. The memory device control circuitry (e.g., control logic) can be programmed to compensate for memory device performance changes corresponding to the wear cycle information. The memory device can receive the wear cycle information and determine one or more operating parameters (e.g., a value, characteristic) in response to the wear cycle information.

It will be understood that when an element is referred to as being “on,” “connected to” or “coupled with” another element, it can be directly on, connected, or coupled with the other element or intervening elements can be present. In contrast, when an element is referred to as being “directly on,” “directly connected to” or “directly coupled with” another element, there are no intervening elements or layers present. If two elements are shown in the drawings with a line connecting them, the two elements can be either be coupled, or directly coupled, unless otherwise indicated.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code can form portions of computer program products. Further, the code can be tangibly stored on one or more volatile or non-volatile tangible computer-readable media, such as during execution or at other times. Examples of these tangible computer-readable media can include, but are not limited to, hard disks, removable magnetic disks, removable optical disks (e.g., compact discs and digital video disks), magnetic cassettes, memory cards or sticks, random access memories (RAMs), read only memories (ROMs), solid state drives (SSDs), Universal Flash Storage (UFS) device, embedded MMC (eMMC) device, and the like.

The above description is intended to be illustrative, and not restrictive. For example, the above-described examples (or one or more aspects thereof) can be used in combination with each other. Other embodiments can be used, such as by one of ordinary skill in the art upon reviewing the above description. It is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A memory device, comprising:
a memory array; and
a memory controller including,
a command queue buffer; and
processing circuitry including one or more hardware processors, the processing circuitry configured to perform operations to implement command prioritization in a command queue of the memory device, the operations comprising:
receive a command at the memory device;
obtain an expiration time for the command;
sort, based on the expiration time for the command, the command among other pending commands by use of a command queue solely ordered by expiration times of commands represented therein, wherein the expiration times of commands represented in the command queue are immutable; and
in response to a representation of the command being at the head of the command queue, initiate performance of the command against the memory array.

2. The memory device of claim 1, wherein, to obtain the expiration time for the command, the processing circuitry is configured to read from a message used to deliver the command to the memory device.

3. The memory device of claim 1, wherein, to obtain the expiration time for the command, the processing circuitry is configured to create the expiration time by the memory device.

4. The memory device of claim 3, wherein, to create the expiration time by the memory device, the processing circuitry is configured to:
obtain a characteristic of the command; and
add a time that the command was received to a time-value corresponding to the characteristic of the command.

5. The memory device of claim 4, wherein the characteristic is a priority of the command.

6. The memory device of claim 5, wherein the expiration time is lower for a higher priority.

7. The memory device of claim 6, wherein a lowest priority has a maximum expiration time.

8. The memory device of claim 6, wherein a highest priority has a zero or negative expiration time.

9. The memory device of claim 1, wherein, to sort the command among other pending commands by use of the command queue solely ordered by expiration times of commands represented therein into the command queue, the processing circuitry is configured to:
place the representation of the command at a tail of the command queue; and
repeatedly swap the representation of the command with a representation of a next command in the command queue when the next command has a larger expiration time that the expiration time for the command.

10. A method for command prioritization in a command queue of a memory device, the method comprising:
receiving a command at the memory device;
obtaining an expiration time for the command;
sorting, based on the expiration time for the command, the command among other pending commands by use of a command queue solely ordered by expiration times of commands represented therein, wherein the expiration times of commands represented in the command queue are immutable; and
in response to a representation of the command being at the head of the command queue, initiating performance of the command against the memory array.

11. The method of claim 10, wherein obtaining the expiration time for the command includes reading from a message deliver the command to the memory device.

12. The method of claim 10, wherein obtaining the expiration time for the command includes creating the expiration time by the memory device.

13. The method of claim 12, wherein creating the expiration time by the memory device includes:
obtaining a characteristic of the command; and
adding a time that the command was received to a time-value corresponding to the characteristic of the command.

14. The method of claim 10, wherein sorting the command among other pending commands by use of the command queue solely ordered by expiration times of commands represented therein into the command queue includes:
placing the representation of the command at a tail of the command queue; and
repeatedly swapping the representation of the command with a representation of a next command in the command queue when the next command has a larger expiration time that the expiration time for the command.

15. A non-transitory machine-readable medium including instructions for command prioritization in a command queue of a memory device, the instructions, when executed, cause processing circuitry of the memory device to perform operations comprising:
receiving a command at the memory device;
obtaining an expiration time for the command;
sorting, based on the expiration time for the command, the command among other pending commands by use of a command queue solely ordered by expiration times of commands represented therein, wherein the expiration times of commands represented in the command queue are immutable; and
in response to a representation of the command being at the head of the command queue, initiating performance of the command against the memory array.

16. The non-transitory machine-readable medium of claim 15, wherein obtaining the expiration time for the command includes reading from a message deliver the command to the memory device.

17. The non-transitory machine-readable medium of claim 15, wherein obtaining the expiration time for the command includes creating the expiration time by the memory device.

18. The non-transitory machine-readable medium of claim 17, wherein creating the expiration time by the memory device includes:
obtaining a characteristic of the command; and
adding a time that the command was received to a time-value corresponding to the characteristic of the command.

19. The non-transitory machine-readable medium of claim 15, wherein sorting the command among other pending commands by use of the command queue solely ordered by expiration times of commands represented therein into the command queue includes:
placing the representation of the command at a tail of the command queue; and
repeatedly swapping the representation of the command with a representation of a next command in the command queue when the next command has a larger expiration time that the expiration time for the command.
